(19) United States
(12) Patent Application Publication
(10) Pub. No.: US 2010/0293394 A1
(43) Pub. Date: Nov. 18, 2010

(54) MOTHERBOARD AND POWER SUPPLY CONTROL CIRCUIT THEREOF

(75) Inventors: YI RUI, Shenzhen City (CN); XIU-DONG LU, Shenzhen City (CN); JING-LI XIA, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/479,867

(22) Filed: Jun. 8, 2009

(30) Foreign Application Priority Data
May 12, 2009 (CN) 200910302229.X

(51) Int. Cl. G06F 1/26

(52) U.S. Cl. 713/300

(57) ABSTRACT

A motherboard of a computer includes a platform controller hub (PCH), a central processing unit (CPU) including a display processing module and a transmission module, a power supply generating module, and a control circuit. The PCH is connected to a display and the display processing module. The display processing module is also connected to the power supply generating module and the control circuit. The transmission module is connected to a graphic card when the graphic card being present in the motherboard. When installed, the graphic card is also connected to the display and the control circuit. The control circuit is also connected to the power supply circuit.

### BACKGROUND

1. Technical Field

The present disclosure relates to motherboards and power supply control circuits, and particularly to a motherboard of a computer and a power supply control circuit for providing power to a display processing module of a central processing unit of the motherboard.

2. Description of Related Art

In recent years, there has been existing a requirement for display of characters and images by using an integrated display function or a graphic card installed to a motherboard of a computer. To implement the integrated display function, a computer needs to provide a power supply generating module to provide power to a display processing module of a central processing unit (CPU). Therefore, the CPU can process display data, and send processed display data to a display to be shown. If the graphic card is installed to the motherboard of the computer, the graphic card can replace the CPU to process the display data. However, power for the display processing module of the CPU is continuously provided whether the module is in use or not, therefore electricity may be wasted.

### BRIEF DESCRIPTION OF THE DRAWINGS

FIG. 1 is a block diagram of an exemplary embodiment of a motherboard of a computer, together with a graphic card and a display, the motherboard including a power supply control circuit.

FIG. 2 is a circuit diagram of an exemplary embodiment of the power supply control circuit of FIG. 1.

### DETAILED DESCRIPTION

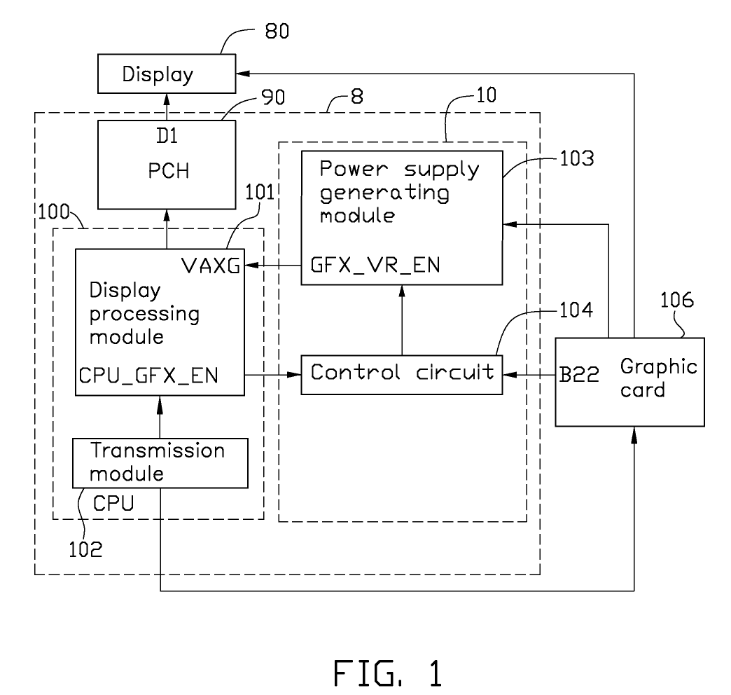

Referring to FIG. 1, an exemplary embodiment of a motherboard 8 with a graphic card 106 connected to a display 80 of a computer. The motherboard 8 includes a platform controller hub (PCH) 90, a central processing unit (CPU) 100, and a power supply control circuit 10. The PCH 90 includes an integrated display interface D1. The CPU 100 includes a display processing module 101 and a transmission module 102. The display processing module 101 includes a power supply pin VAXG and a power supply enable pin CPU_GFX_EN. The graphic card 106 includes a ground pin B22. When installed, the graphic card 106 is connected between the transmission module 102 of the CPU 100 and the display 80 and is also connected to the power supply control circuit 10.

The PCH 90 is connected to the display 80 via the integrated display interface D1, and also connected to the display processing module 101. The power supply enable pin CPU_GFX_EN and the power supply pin VAXG of the display processing module 101 are connected to the power supply control circuit 10. The power supply control circuit 10 is also connected to the ground pin B22.

The power supply control circuit 10 is to detect whether the graphic card 106 is present in the motherboard 8, thereby determining whether or not to supply power to the power supply pin VAXG of the display processing module 101, and whether to allow the motherboard 8 to implement an integrated display function or disable that function in favor of the graphic card 106 when it is installed. The power supply control circuit 10 includes a power supply generating module 103 and a control circuit 104. The power supply generating module 103 includes a control pin GFX_VR_EN.

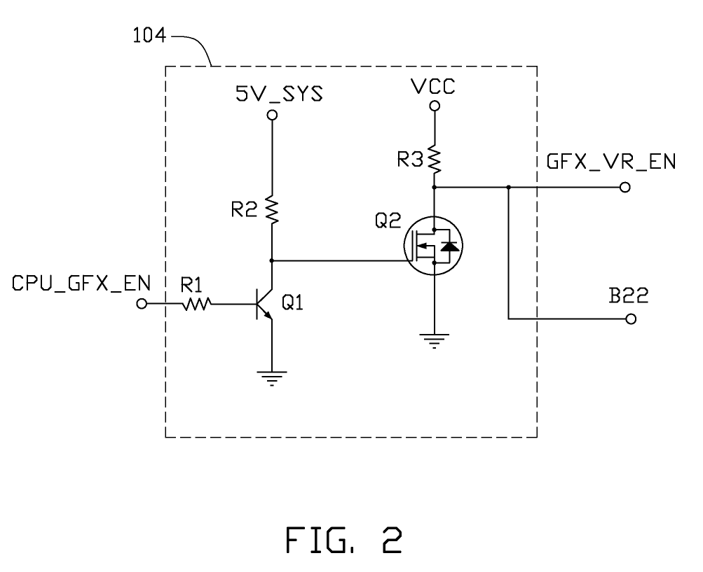

Referring to FIG. 2, the control circuit 104 includes a transistor Q1, a field effect transistor (FET) Q2, and resistors R1-R3. A base of the transistor Q1 is connected to the power supply enable pin CPU_GFX_EN of the display processing module 101 via the resistor R1. An emitter of the transistor Q1 is grounded. A collector of the transistor Q1 is connected to a power supply 5V_SYS via the second resistor R2, and also connected to a gate of the FET Q2. A source of the FET Q2 is grounded. A drain of the FET Q2 is connected to the control pin GFX_VR_EN of the power supply generating module 103 and also connected to the ground pin B22 of the graphic card 106 when the graphic card 106 is present, and is also connected to a power supply VCC via the resistor R3. In this embodiment, the power supply VCC can be a 5V, 3.3V, or 1.1V direct current (DC) power supply, the power supply 5V_SYS can be a 5V system power supply, the resistance of the resistors R1-R3 can be 4.7 kΩ, 10 kΩ, and 10 kΩ respectively, the transistor Q1 can be an npn transistor, and the FET Q2 can be an n-channel metal oxide semiconductor (NMOS) FET. In other embodiments, the transistor Q1 and the FET Q2 can be other types of electronic switches.

The following is to describe a working process of the power supply control circuit 10. When the graphic card 106 is not present in the motherboard 8 and the motherboard 8 is powered on, the power supply enable pin CPU_GFX_EN of the display processing module 101 of the CPU 100 is at high level, such as 5V. The base of the transistor Q1 of the control circuit 104 is at high level, such as 5V, and the transistor Q1 is turned on. The gate of the FET Q2 is at low level, such as 0V, and the FET Q2 is turned off. The control pin GFX_VR_EN of the power supply generating module 103 is at high level, such as 5V. The power supply generating module 103 provides power to the power supply pin VAXG of the display processing module 101 of the CPU 100. Therefore, the display processing module 101 of the CPU 100 can process display data from the transmission module 102, and send the processed display data to the display 80 to be shown, via the PCH 90 and the integrated display interface D1. When the graphic card 106 is present in the motherboard 8 and the motherboard 8 is powered on, the ground pin B22 of the graphic card 106 is at low level, such as 0V, and the control pin GFX_VR_EN of the power supply generating module 103 is at low level, such as 0V. Therefore, the power supply generating module 103 stops providing power to the power supply pin VAXG of the display processing module 101 of the CPU 100, and the display processing module 101 stops working. The transmission module 102 of the CPU 100 sends display data to the graphic card 106 to be processed, and the graphic card 106 sends the processed display data to the display 80 to be shown.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A motherboard connected to a display of a computer, the motherboard comprising:
a platform controller hub (PCH) connected to the display;
a central processing unit (CPU) comprising a display processing module and a transmission module, wherein the display processing module is connected to the PCH, the transmission module of the CPU is connected to a graphic card when the graphic card being present in the motherboard;
a power supply generating module connected to the display processing module; and
a control circuit connected between the power supply generating module and the display processing module, to control the power supply generating module to supply power to the display processing module when no graphic card is present in the motherboard, therefore the display processing module processing display data from the transmission module and sending processed display data to the display via the PCH, wherein the control circuit is connected to the graphic card when the graphic card being present in the motherboard;
wherein when the graphic card is present in the motherboard, the power supply generating module does not supply power to the display processing module, the graphic card processes display data from the transmission module, and sends processed display data to the display to be shown.

2. The motherboard of claim 1, wherein the control circuit comprising:
a first electronic switch to close when the graphic card being not present in the motherboard; and
a second electronic switch to open when the first electronic switch being close.

3. The motherboard of claim 2, wherein the first electronic switch comprises a first terminal connected to a display processing module of the CPU via a first resistor, a second terminal grounded, and a third terminal connected to a first power supply via a second resistor.

4. The motherboard of claim 3, wherein the first electronic switch is an npn transistor.

5. The motherboard of claim 3, wherein the second electronic switch comprises a first terminal connected to the third terminal of the first electronic switch, a second terminal grounded, and a third terminal connected to the power supply generating module and the graphic card when the graphic card being present in the motherboard, and a second power supply via a third resistor.

6. The motherboard of claim 5, wherein the second electronic switch is a field effect transistor.

7. A power supply control circuit, comprising:
a power supply generating module;
a first electronic switch to close when the power supply control circuit being unconnected to a graphic card; and
a second electronic switch to open when the first electronic switch being close; therefore triggering the power supply generating module to provide power when the power supply control circuit being unconnected to the graphic card.

8. The circuit of claim 7, wherein the first electronic switch comprises a first terminal connected to a display processing module of the CPU via a first resistor, a second terminal grounded, and a third terminal connected to a first power supply via a second resistor.

9. The circuit of claim 8, wherein the first electronic switch is an npn transistor.

10. The circuit of claim 7, wherein the second electronic switch comprises a first terminal connected to the third terminal of the first electronic switch, a second terminal grounded, and a third terminal connected to the power supply generating module and the graphic card when the graphic card is present in the motherboard, and a second power supply via a third resistor

11. The circuit of claim 10, wherein the second electronic switch is a field effect transistor.
